(19) United States
(12) Patent Application Publication
(10) Pub. No.: US 2007/0130506 A1
(43) Pub. Date: Jun. 7, 2007

(54) Method and system for improving usability of online forms via an automatic field completion functionality

(76) Inventor: Michael Danninger, Landau (DE)

Correspondence Address: KENYON & KENYON LLP, ONE BROADWAY, NEW YORK, NY, 10004, US

(21) Appl. No.: 11/293,659

(22) Filed: Dec. 1, 2005

(51) Int. Cl. G06F 17/00; G06F 17/30

(52) U.S. Cl. 715/507; 715/505; 707/3

(57) ABSTRACT

A software tool populates an online interactive form with a set of values based on one or more basic values entered by the user in the online form.

### BACKGROUND

The present invention relates to a tool for assisting a user in the completion of online interactive forms. Specifically, when a user fills in a minimum number of basic fields in an interactive form, the present invention provides proposal values in some or all of the remaining fields based on the information entered by the user.

Online interactive forms are an integral part of the business world. They are used in many different contexts, such as customer order forms and human resources forms. These forms often contain numerous fields that must be completed. The process of filling out such forms can be tedious and time consuming. On numerous occasions the values for many of the fields could be determined based on a user input of a few basic fields. Therefore, it would be useful to provide assistance to the user in filling out these forms, by providing proposal values for some of the fields after the user fills out a small number of fields. By using a basic amount of fields to generate default values for other fields, the user would not need to go through many fields and enter many values. This would cut down on transaction costs and make filling out these forms more user friendly.

### BRIEF DESCRIPTION OF THE DRAWINGS

FIG. 1 is a simplified block diagram of a computer system according to an embodiment of the present invention;

FIG. 2A is a diagram of an embodiment of a decision search tree saved in memory;

FIGS. 2B-2C represent traversals over particular branches of the decision tree in FIG. 2A and values associated with those traversals;

FIG. 3 is a dataflow diagram illustrating the operation of one embodiment of the present invention;

FIG. 4 is a dataflow diagram illustrating the operation of another embodiment of the present invention; and

FIG. 5A-5B are screen shots of an online form illustrating the operation of the present invention.

### DETAILED DESCRIPTION

Embodiments of the present invention work cooperatively with existing online interactive forms to present proposal values for certain fields based on a few basic values entered by the user. The user fills in the requisite number of fields in an online interactive form and selects an option on the form for providing proposal values for the other fields. The filled-in fields are sent by the system as an input to a field completion module, which uses the input to navigate the decision tree in the appropriate resource which is associated with the online form. The resource may, for example, be a database accessible via an intranet. The field completion module obtains from traversing the decision tree default values possible for the other fields. Each decision tree is uniquely associated with an online interactive form.

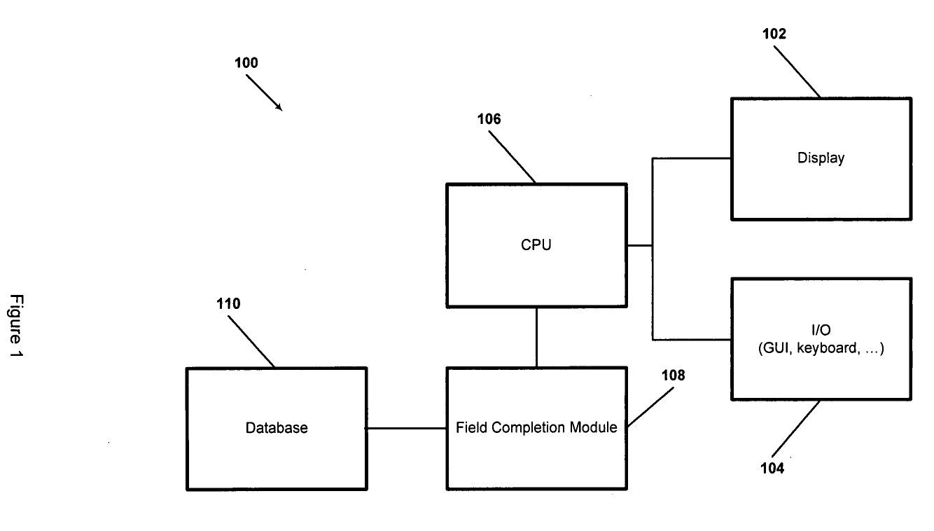

FIG. 1 is a simplified block diagram of an exemplary computer system 100 suitable for use with the present invention. A user inputs at least one value in an interactive online form by way of an input/output device 104, such as a keyboard or a mouse, for example. An interactive online form may contain several fields. For example, a customer order form may contain the following fields: product, model number, quantity. The CPU 106 receives the input (i.e. the user-entered field values) and passes it onto the field completion module 108. The CPU 106 also sends a reference to the field completion module 108 that indicates which online form the input is associated with. The field completion module 108 then traverses the decision tree in the database 110 that is uniquely associated with the online form related to the user input. If the user has entered all the basic values, the field completion module 108 may be able to completely traverse the decision tree, and in doing so determine values for the fields that the user did not fill in. When the field completion module 108 finishes traversing the associated decision tree in the database 110, it may access a set of values based on the data generated by the decision tree if the user has inputted all of the basic values. This access involves reading the values correlating to the data that the traversal of the decision tree produced. If the user has entered only a subset of the basic values, the field completion module 108 may traverse the decision tree only as far as possible. Thereafter, the field completion module 108 returns the accessed values to the CPU 106, and directs which fields in the related online interactive form should be filled in with the retrieved data. For each data field which is filled in with defaulted data by the CPU 106, it may contain one value or a drop down menu of several possible values based on the information entered by the user.

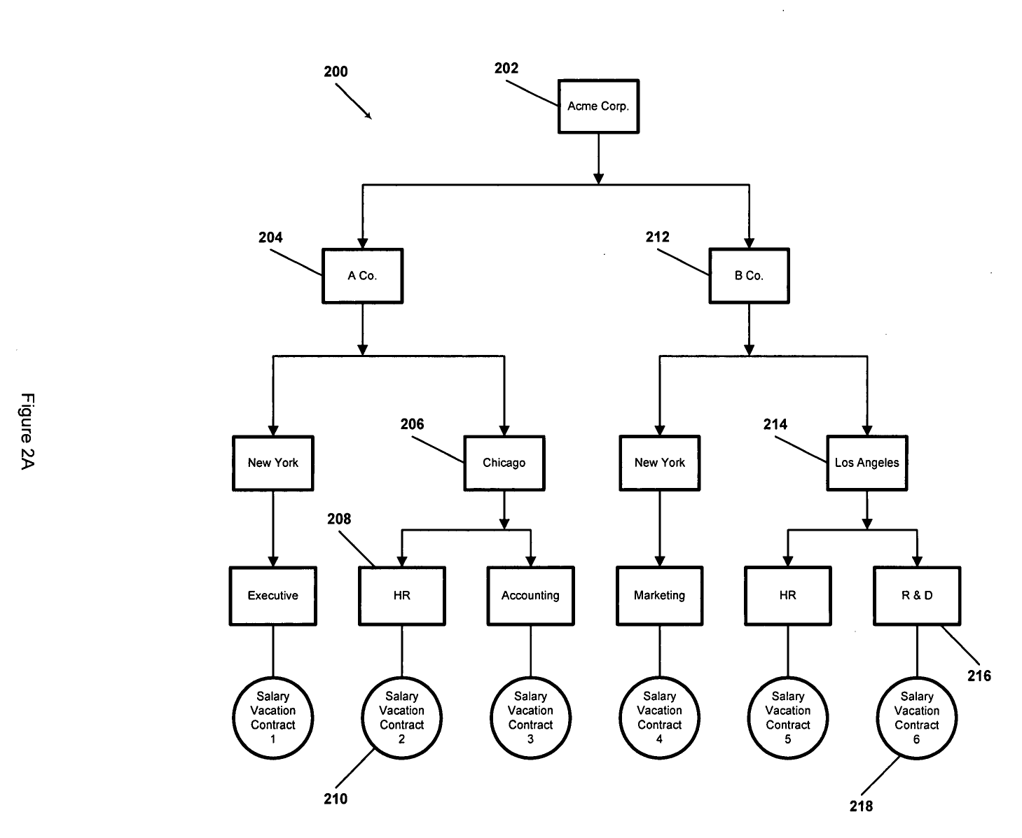

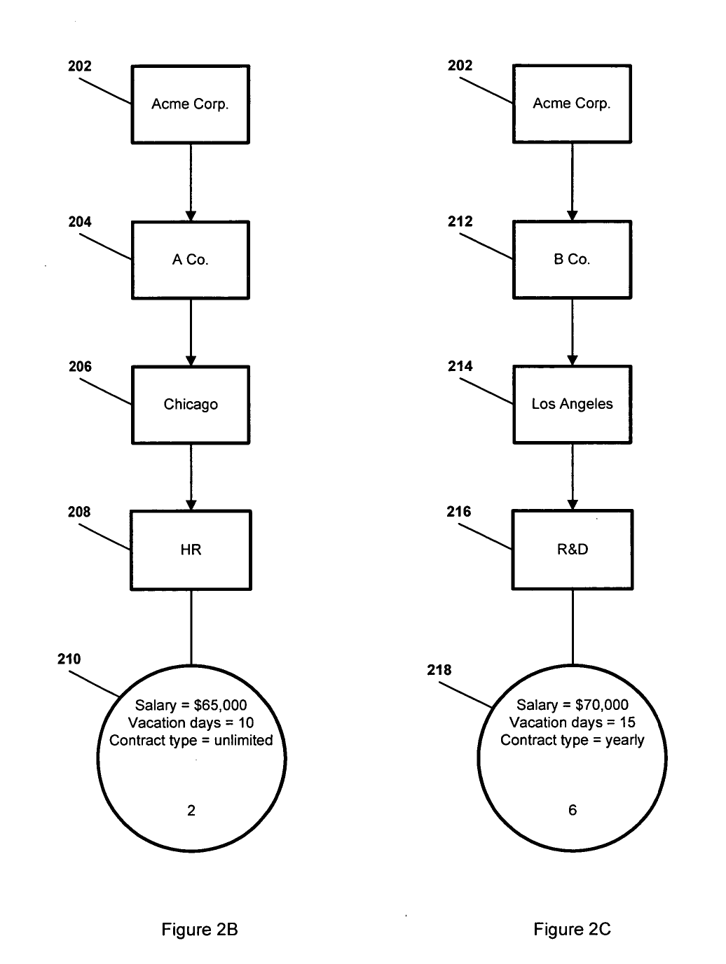

FIG. 2A illustrates an exemplary embodiment of decision tree 200 which is contained in the database 110 and associated with an online form containing the fields of company name, subdivision, city, position, salary, vacation days, and contract type. Although FIG. 2A presents an example based on a decision tree data structure, the present invention is compatible with any searchable data structure capable of relating a user-entered information item to other information items that the present invention uses to automatically populate the remaining fields of an online form. In this embodiment of the present invention, the basic values to be inputted by the user are: company name, subdivision, city, and position. If the user inputs all these basic values, the field completion module 108 will be able to traverse the decision tree 200 and obtain values for other associated fields, namely salary, vacation days, and contract type.

FIGS. 2B-2C illustrate two different traversals of decision tree 200. In FIG. 2B, the user enters the following values in the online interactive form: Acme Corp. 202 for company name, A Co. 204 for subdivision, Chicago 206 for city, and HR 208 for employment position. When the field completion module 108 uses these values to traverse the decision tree 200, it reaches the associated values of salary, vacation days and contract type that are uniquely associated with an HR position in Chicago for the A Co. subdivision of Acme Corp. As shown in data entry 210, salary is $65,000, vacation days are 10, and contract type is unlimited. The field completion module 108 may pass these values to the CPU 106, which may, in turn, populate the corresponding fields of the online form with the values.

In FIG. 2C, the user enters the following values in the online interactive form: Acme Corp. 202 for company name, B Co. 212 for subdivision, Los Angeles 214 for city, and R&D 216 for position. When the field completion module 108 uses these values to traverse the decision tree 200, it reaches the associated values of salary, vacation days and contract type that are uniquely associated with the four basic values entered. As shown in data entry 218, salary is $70,000, vacation days are 15, and contract type is yearly. The field completion module 108 may pass these values to the CPU 106, which may, in turn, populate the corresponding fields of the online form with the values.

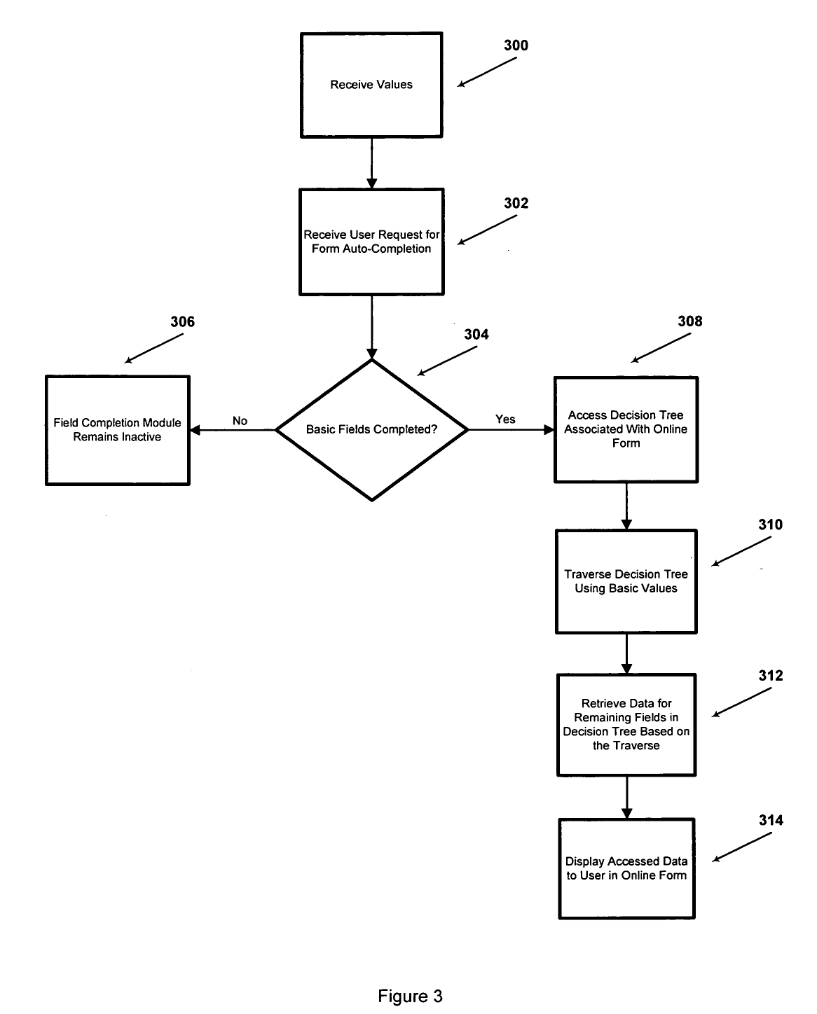

FIG. 3 is a dataflow diagram illustrating an operation of the field completion module 108 for one embodiment of the present invention which operates in conjunction with the decision tree referenced in FIGS. 2A-2C. In this embodiment, the field completion module 108 operates only if all the basic data values for a predetermined number of fields in the online form have been inputted by the user. The method begins when a user enters at least one basic value in an online interactive form by way of an input/output device 104, step 300. The user then requests, by way of an input/output device 104, that the CPU 106 automatically fill in some of or the rest of the form. After receiving the user request, step 302, the CPU 106 forwards the value(s) inputted by the user and a reference to the online interactive form to the field completion module 108, which, after accessing from database 110 the decision tree for the form and the number of fields that a user must fill in, then determines whether all the basic values for the required fields that a user must enter have been filled in, step 304. If not, the automatic field completion function may be inactive, step 306. The user may be prompted to enter all basic fields before the field completion module 108 may become operable. If the field completion module 108 determines that all basic values have been inputted by the user, it accesses the decision tree associated with the online form which is stored in the database 110, step 308. The field completion module 108 then traverses the accessed decision tree using the basic values inputted by the user, step 310. Once the field completion module 108 has successfully traversed the accessed decision tree, it retrieves the related data associated with its traverse of the tree, step 312. For example, in the online form associated with decision tree 200, the user may enter Acme Corp. 202 for the company name, A Co. 204 for the subdivision, Chicago 206 for city and HR 208 for position. The field completion module 108 may take those values and traverse the decision tree 200 in FIG. 2A. The traversal of the decision tree may access the related fields 210 of salary, vacation days and contract type. The CPU 106 then populates the relevant fields of the online form with the accessed data, step 314. The salary field may be populated with $65,000, the vacation days field may be populated with 10, and the contract type field may be populated with unlimited.

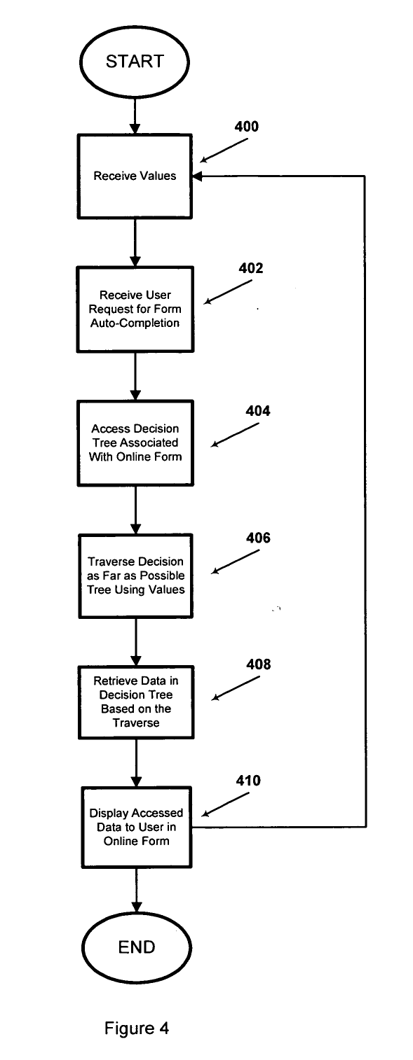

FIG. 4 is a dataflow diagram of an alternative embodiment of the present invention which operates in conjunction with the decision tree in FIGS. 2A-2C. In this embodiment, the field completion module operates whether or not all the basic data values have been entered by the user. The method begins the same way as the one in FIG. 3, but differs in regard to steps 404, 406, 408, 410. Rather than first determining whether all the basic values have been entered by the user, this embodiment of the present invention uses whatever information the user has inputted to attempt to traverse the associated decision tree. When the user requests auto-form completion, the CPU 106 forwards this request to the field completion module 108, which accesses the decision tree associated with the online form associated with the user request, step 404. The field completion module 106 traverses the decision tree as far as possible, using the values entered by the user, step 406. The field completion module 108 next retrieves data based on its traversal of the decision tree, step 408. If all the basic values were entered by the user, the field completion module 108 may reach the end of the decision tree, and access the related data (as in the embodiment described in FIG. 3). However, even if not all basic values were entered by the user, the field completion module 108 may still traverse the decision tree as far as possible, and display the information it retrieves in the online form, step 410. For example, in the online form associated with decision tree 200, the user may enter Acme Corp. 202 for the company name and A Co. 204 for the subdivision. The field completion module 108 may take those values and attempt to traverse the decision tree 200 in FIG. 2A. The traversal would end at the second level, because the user did not input all of the basic values (e.g. did not enter Chicago and HR). However the field completion module 108 may take the basic values entered by the user and utilize them to narrow the remaining fields via drop down menus. For example, since Acme Corp. 202 and A Co. 204 are only associated with the cities New York and Chicago, the field completion module 108 would send both these values to the CPU 106. The CPU 106 would, in turn, populate the “city” field of the online form with a drop down menu containing the options New York and Chicago. Also, since Acme Corp. 202 and A Co. 204 are only associated with the positions executive, HR, and accounting, the field completion module 108 would send all three of these values to the CPU 106. The CPU 106 would, in turn, populate the “position” field of the online form with a drop down menu containing the options executive, HR and accounting.

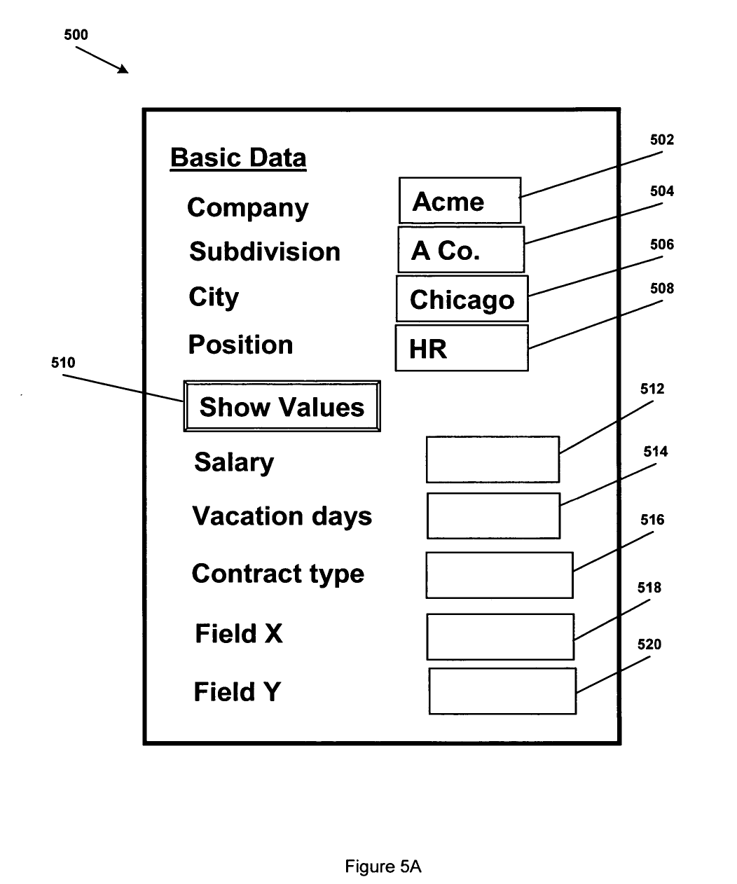

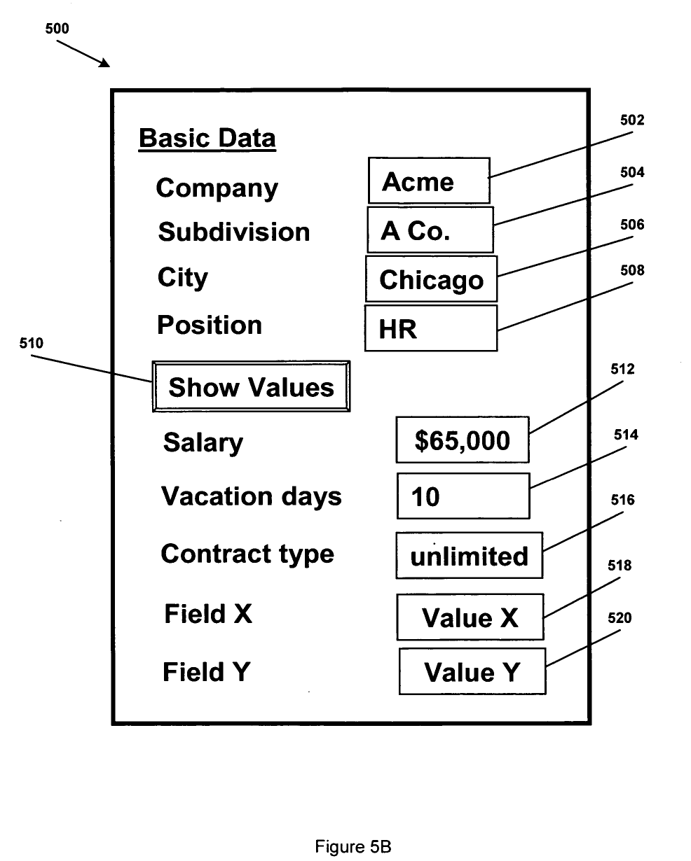

FIG. 5A is a graphical user interface of an online interactive form 500 incorporating the present invention. The online interactive form 500 contains several basic fields for user input, namely company 502, subdivision 504, city 506 and position 508. In this computer screen, the automatic field completion functionality is disabled. The middle of this screen includes a button 510 entitled “Show Values” for toggling the automatic field completion functionality on and off.

FIG. 5B depicts what happens after the user clicks on button 510. After the automatic field completion functionality is turned on, the data accessed by the field completion module 108 is placed in the appropriate fields by the CPU 106. Thus, the salary field 512 is filled with $65,000, the vacation days field 514 is filled with 10, the contract type field 516 is filled with unlimited, and field X 518 and field Y 520 are filled with value X and value Y respectively.

1. A method of automatically filling in an online form containing a plurality of fields, comprising:
receiving an information item for at least one field;
based on the information item, automatically determining another information item for at least one of the remaining fields; and
filling in the at least one remaining field with the determined other information item.

2. The method of claim 1, wherein the automatically determining includes searching through a data structure relating the received information item to the other information item.

3. The method of claim 1, wherein the receiving includes receiving the information item from a user.

4. The method of claim 3, wherein the automatic determining occurs only if all basic fields have been filled in by the user.

5. An article of manufacture comprising a computer readable medium storing instructions adapted to be executed by a processor, the instructions, when executed, defining a method for conducting automatic field completion in an online form containing a plurality of fields, the method comprising:
receiving an information item for at least one field;
based on the information item, automatically determining another information item for at least one of the remaining fields; and
filling in the at least one remaining field with the determined other information item.

6. The method of claim 5, wherein the automatically determining includes searching through a data structure relating the received information item to the other information item.

7. The method of claim 5, wherein the receiving includes receiving the information item from a user.

8. The method of claim 7, wherein the automatic determining occurs only if all basic values have been inputted by the user.

9. A computer system for automatically filling in values in an online form containing a plurality of fields, comprising:
an arrangement for receiving an information item for at least one field;
an arrangement for automatically determining, based on the information item, another information item for at least one of the remaining fields; and
an arrangement for filling in the at least one remaining field with the determined other information item.

10. An online form for display on a display device, comprising:
a field capable of receiving a user input;
a selectable display element for activating an automatic field completion function that provides at least one default value based on a content of the field; and
another field capable of displaying said at least one default value.

11. The online form of claim 10, wherein the content is based on the user input.

12. The method of claim 2, wherein:
the data structure is a tree structure having a plurality of nodes;
the searching includes, based on the received information item, traversing the tree structure from a highest level parent node to a last one of the plurality of nodes that corresponds to the received information item; and
the determining includes traversing and recording nodes of the tree structure that follow the last node.

13. The method of claim 12, wherein the determining is performed conditional upon all of the nodes that follow the last node belonging to a single branch of the tree structure.

14. The method of claim 12, wherein:
the determining is performed even if different ones of the nodes that follow the last node belong to different branches of the tree structure; and
for each particular level of the tree structure that follows a level to which the last node belongs and to which belong more than one of the nodes that follow the last node, the filling in includes filling in a field of the at least one remaining field that corresponds to the particular level with a drop down box including a plurality of selectable entries, different ones of the entries corresponding to different nodes of the particular level.
